(19) United States
(12) Patent Application Publication
(10) Pub. No.: US 2016/0217507 A1
(43) Pub. Date: Jul. 28, 2016

(54) Method of Fundraising with an Educational Webinar/Program

(71) Applicant: Patricia K. Carl, Minneapolis, MN (US)

(72) Inventor: Patricia K. Carl, Minneapolis, MN (US)

(21) Appl. No.: 14/607,384

(22) Filed: Jan. 28, 2015

(51) Int. Cl. G06Q 30/02; G06Q 50/20; G06Q 30/06

(52) U.S. Cl. CPC G06Q 30/0279; G06Q 30/0633; G06Q 50/205

(57) ABSTRACT

A system capable of supporting and managing a plurality of fundraising campaigns that provides the participant with life-changing educational webinars/programs and a physical product as incentive donate. Educational webinars/programs contain gratitude-teaching content that increases an individual's well-being and happiness. The physical product serves as a reminder of the gratitude teachings disclosed in the educational webinars/programs. The system includes a common board for user accounts to post to and interact with in accordance with gratitude-teachings. Additionally, the system periodically retrieves gratitude statements from each of the users. Gratitude statements include user-determined list of things describing what the user is grateful for in their lives. Furthermore, the system includes an online store portal to allow arbitrary individuals the opportunity to donate to fundraising campaigns.

### FIELD OF THE INVENTION

The present invention relates generally to methods for collecting monetary funds for non-profit organizations. More specifically, the present invention is a fundraising method which utilizes a learning webinar/program in conjunction with a specialized product as an incentive for participation in the fundraising campaign.

### BACKGROUND OF THE INVENTION

Gratitude, or appreciation, is the acknowledgement and recognition of the good attributes of one's life: social connections, family, materials, abilities, personal development and health to name a few. Appreciation ideology is a personal perspective on what one has versus what one lacks and has been linked to numerous psychological benefits. These psychological benefits can directly affect the happiness and performance of an individual. A contrary perspective, consumerism is an ideology centered around the aggregation of goods and services. This ideology encourages individuals to buy and/or obtain goods, consume materials, and services in excess amounts, most often past the basic needs of the individual. Consumerism is promoted by the media culture as well as large scale corporations and is therefore a highly popular perspective in modern society. With the right resources and proper self-restraint, there are benefits to consumerism that promote a happy environment. In alternative cases where insecurities, financial and/or emotional, are present the consumer ideology begins to take a toll on the individual and has been linked to unhappiness.

In today's society, there is too much focus on consumerism. With the proper education and training appreciation ideology is simple and easy to implement. With appreciation ideology, a person's well-being and happiness may be increased which in turn promotes a more caring and happy environment around the individual. Some of the physiological benefits of gratitude and appreciation ideology include increased serotonin levels, balanced hormonal levels, release of anti-aging hormones, and increased energy. Additionally, over time the brain and heart rhythms create a body-wide shift to a scientifically measurable state called “coherence”. In this optimal state, the body systems function more efficiently, generating a greater balance of emotions, increased mental clarity, and brain function. One of the main objectives of the present invention is to promote appreciation ideology in a community-based setting such that individuals may participate and see each other's progress together, creating a more cohesive environment. Through the process of promoting appreciation ideology the present invention also raises a substantial amount of money for a charity or other similar type of entity. The fundraising aspect of the present invention is intertwined into the appreciation ideology education and aids in promoting the ideology. In work environments, the benefits are enormous. Some of the benefits are increased harmony, better communication, increased productivity, more laughter, cooperation, and inspiration. The present invention may be modified and altered to accommodate any type of community or social group.

### BRIEF DESCRIPTION OF THE DRAWINGS

FIG. 1 is a flow chart depicting a portion of the general process of the present invention.

FIG. 2 is a flow chart depicting the continuation of the general process of the present invention.

FIG. 3 is a flow chart depicting the steps for collecting the preliminary information.

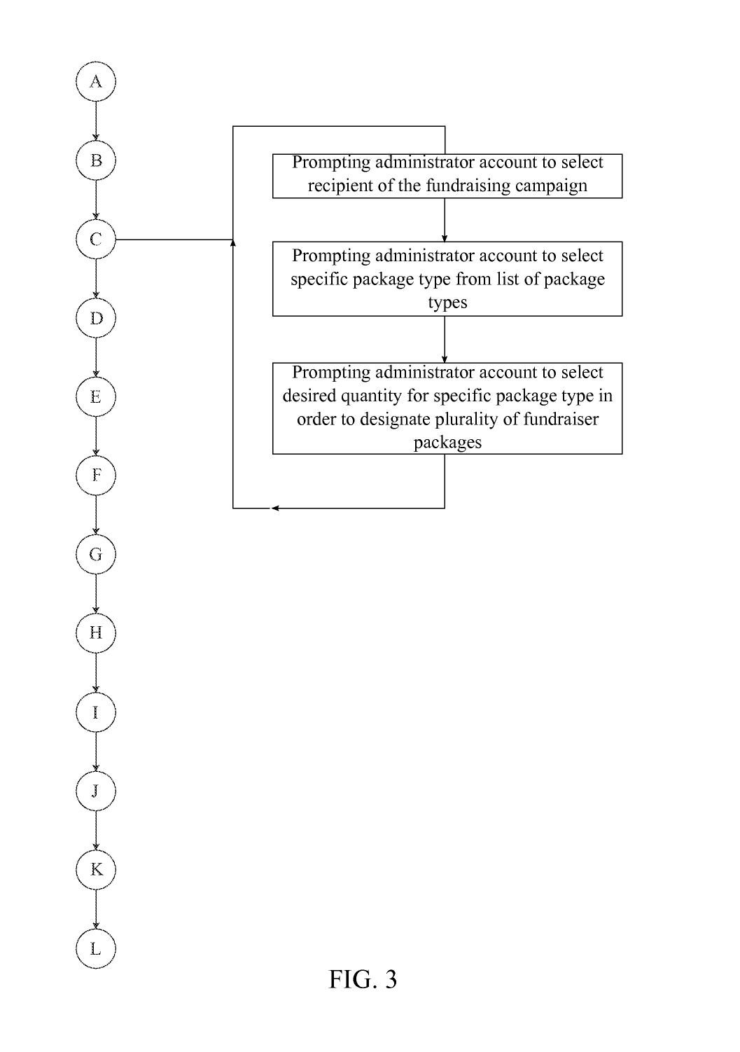

FIG. 4 is a flow chart depicting the steps for collecting the electronic funds for the fundraising campaign.

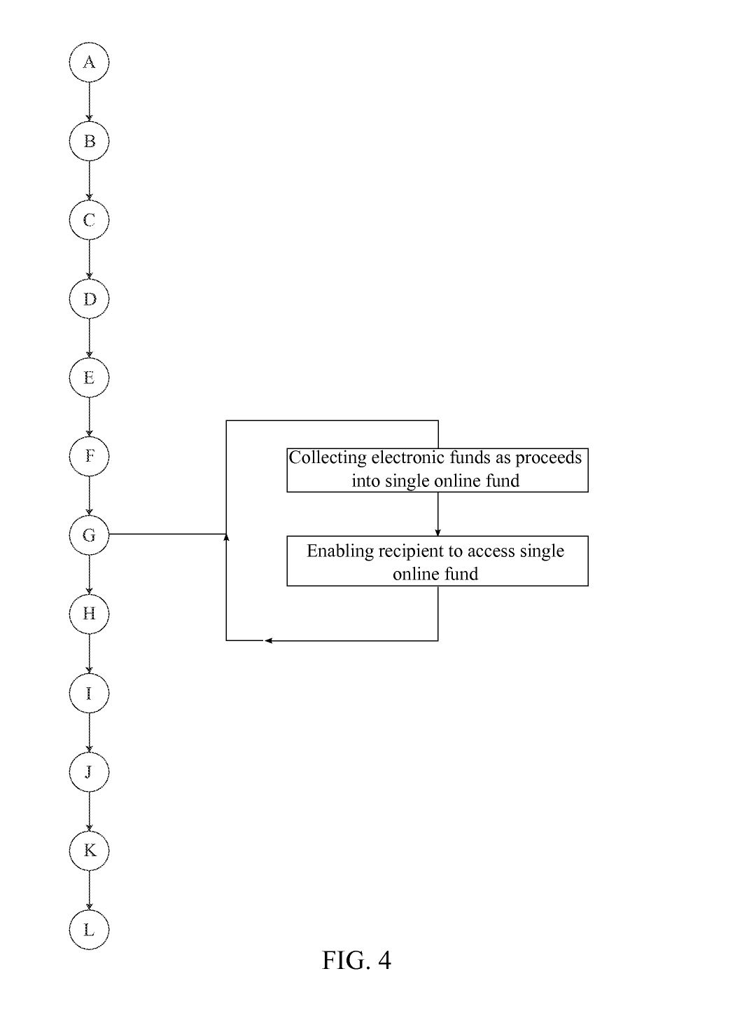

FIG. 5 is a flow chart of the webinar portal feature of the present invention.

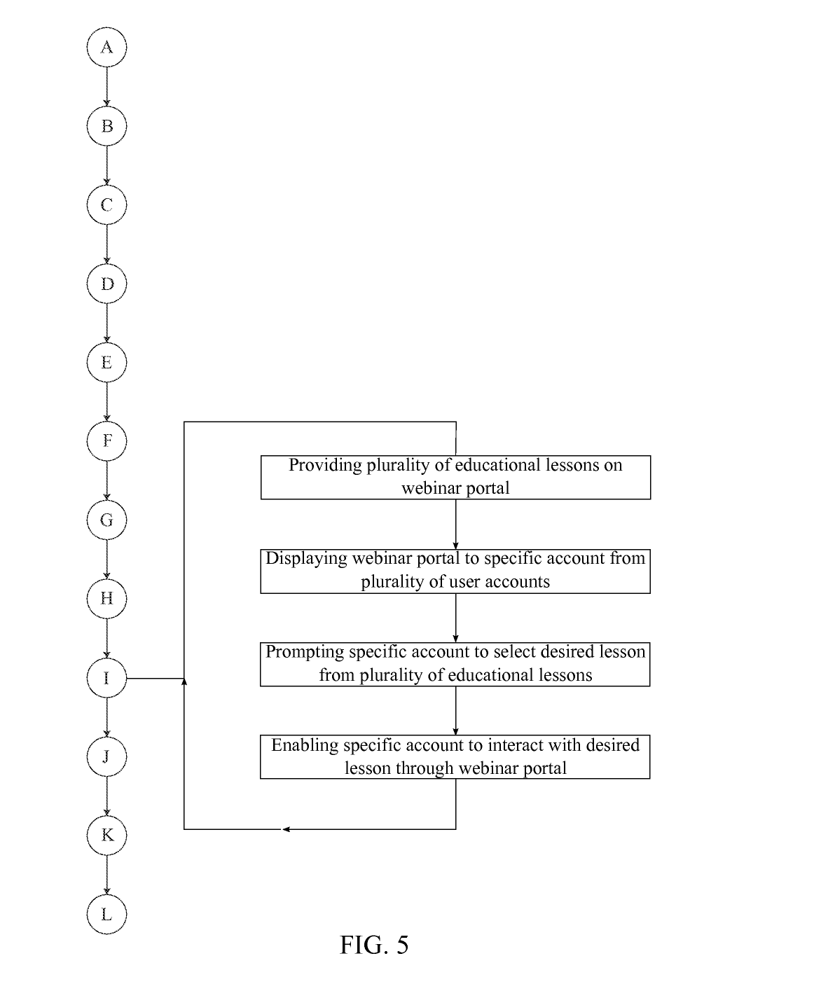

FIG. 6 is a flow chart of the common board feature of the present invention.

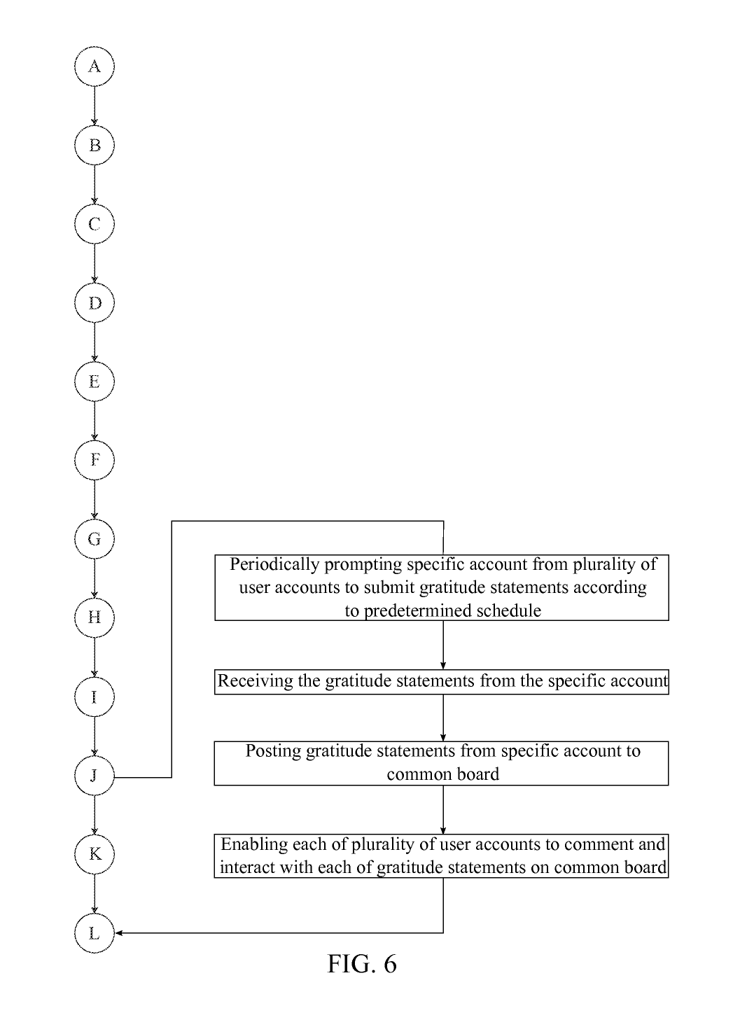

FIG. 7 is a flow chart of the online store portal feature of the present invention.

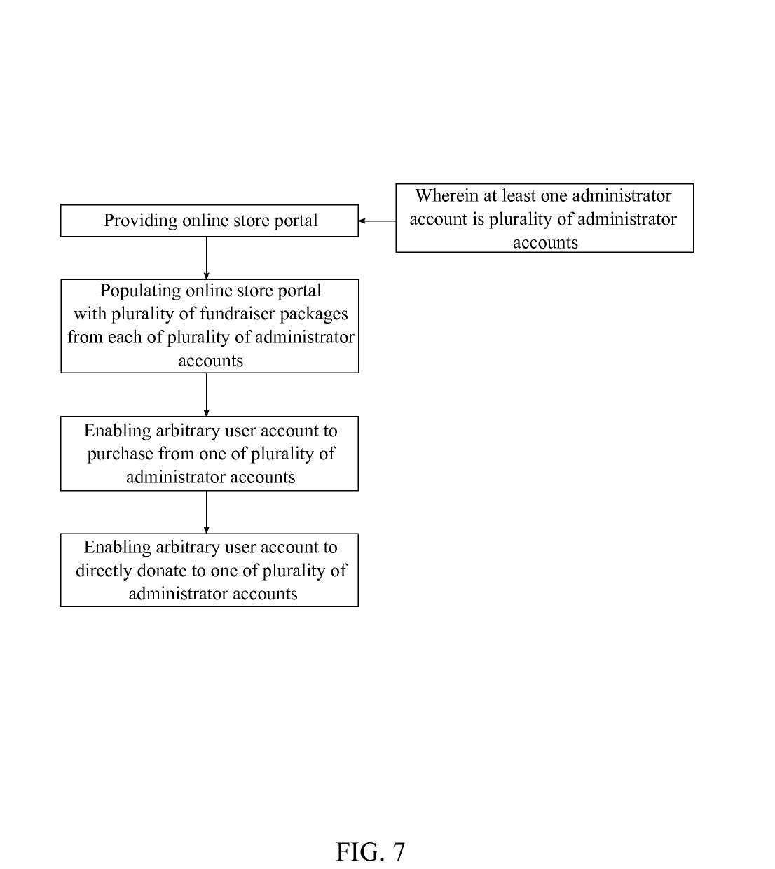

### DETAIL DESCRIPTIONS OF THE INVENTION

All illustrations of the drawings are for the purpose of describing selected versions of the present invention and are not intended to limit the scope of the present invention.

The present invention is a fundraising method which utilizes an educational webinar/program to educate the participants of the fundraiser about gratitude and appreciation ideology. Additionally, the present invention includes a physical product/item which serves as a supplementary incentive to participate in the fundraising campaign as well as a reminder to practice appreciation ideology on a daily basis. Any individual, group, community, and entity may launch a fundraising campaign with the aid of the present invention. The present invention provides the structural backbone for a fundraising campaign as well as additional educational webinars/programs which improve individual well-being and happiness. In the preferred embodiment, the system implementing the steps of the present invention is an Internet-based software application that is operated and managed by at least one server. The present invention may be viewed, accessed, and interacted with by different users from any kind of web-enabled computing device such as a smart phone, a desktop computer, a laptop, an a tablet personal computer.

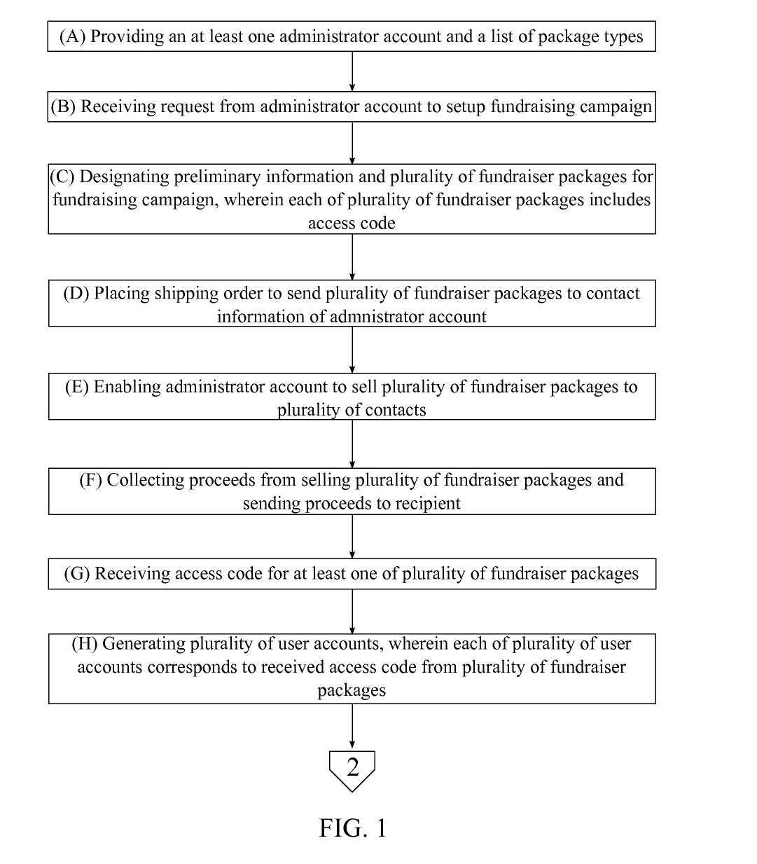

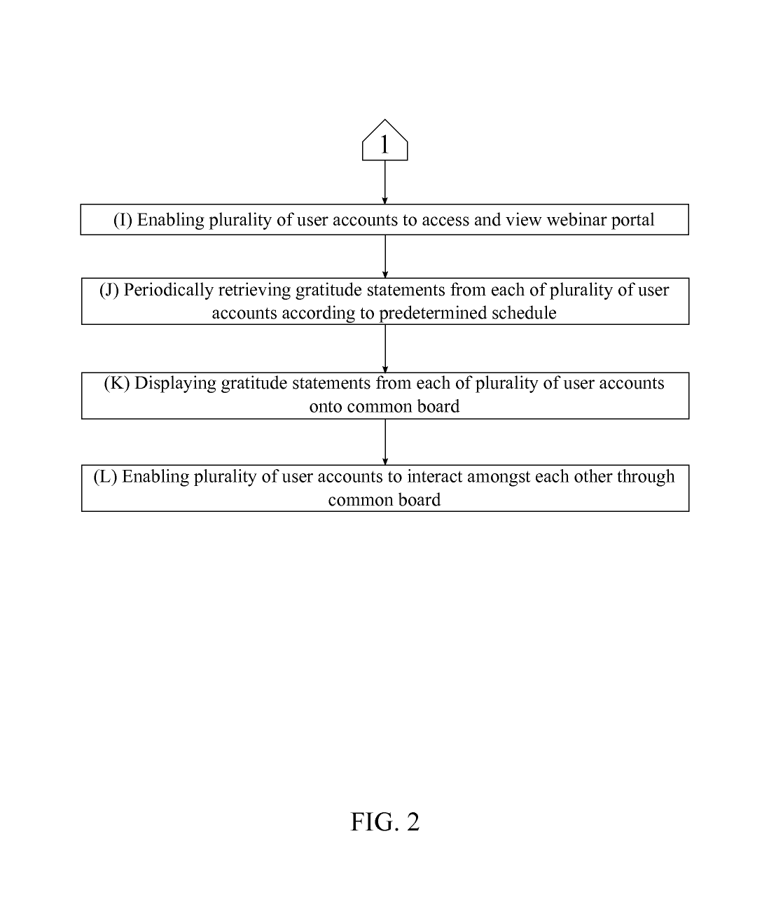

Referring to FIG. 1 and FIG. 2, the overall process of the present invention begins with the system being provided with at least one administrator account and a list of package types. The administrator account is a fundraiser organizer and may be any individual, group, community, or entity that wishes to utilize the present invention in a fundraising campaign. The system can manage a plurality of administrator accounts and therefore a plurality of fundraiser campaigns. The listed processes below are in reference to a single fundraiser campaign; it is understood that the system implementing the present invention can support more than one fundraiser campaign at one time. The list of package types is a multitude of fundraiser package types that are going to be sold in order to obtain monetary donations to the fundraising campaign. Fundraiser package types include jewelry, trinkets, food items, services, and other similar products.

The method of the present invention begins when an administrator account submits a request to start a fundraising campaign to the Internet-based application. The system then designates preliminary information and a plurality of fundraiser packages for the fundraiser campaign based on the information entered by the administrator account. Each of the plurality of fundraiser packages includes an access code that is logged and tied to the associated administrator account. Next, a shipping order is placed to send the plurality of fundraiser packages to the contact information of the administrator account. This provides the administrator account with specialized product for their fundraising campaign. By delivering the plurality of fundraiser packages, the system enables the administrator account to sell the plurality of fundraiser packages to a multitude of contacts; this is most often accomplished through the aid of volunteers. The administrator account may use social media, volunteers, and fundraising programs to sell the fundraiser packages. Once the plurality of fundraiser packages is sold, the proceeds are collected and sent to a selected recipient.

The present invention also utilizes an educational webinar/program as an incentive to participate in the fundraising campaign and to convey gratitude and appreciation ideology. The webinar/program is offered to participants of the fundraising campaign and may be accessed on the Internet-based application. To access the webinar/program and additional features of the present invention, an individual enters his/her access code obtained from the fundraiser package into the Internet-based application and creates a user profile. Once the system receives an access code for at least one of the plurality of fundraiser packages, a user account is generated which corresponds to said access code and user profile of said individual. This process repeats to generate a plurality of user accounts, wherein each of the plurality of user accounts corresponds to a received access code from each of the plurality of fundraiser packages. Through the user account, the system enables each individual to access and view a webinar/program portal on the Internet-based application. The webinar/program portal comprises a plurality of educational lessons which contain gratitude-teaching content; a user account may access these lessons at any time he/she pleases. One of the main gratitude teachings is called the appreciation challenge in which the individual writes down five things that he or she appreciates each day for 30 days. The individual will notice profound changes in every area of his/her life which will manifest more happiness, joy, and contentment. The system aids each of the user accounts in fulfilling this challenge by periodically prompting and retrieving a gratitude statement from each of the plurality of user accounts according to a predetermined schedule, preferably on a daily basis. The gratitude statement includes a list of things that the individual is grateful for in their life. The system then displays the gratitude statement from each of the plurality of user accounts onto a common board for others to view. The system populates the common board with the gratitude statements and enables the plurality of user accounts to interact amongst each other and consequently creates a culture of appreciation and gratitude.

The present invention also follows a number of secondary processes, sub-steps of the overall processes. One secondary process includes the gathering of preliminary information regarding each specific fundraising campaign. The preliminary information includes a recipient of the fundraising campaign, a specific package type, and a desired quantity of the specific package type. The system prompts the administrator to select/enter the preliminary information prior to launching the campaign on the Internet-based application. For each fundraising campaign, the system prompts the administrator account to select the recipient of the fundraising campaign; a non-profit organization, a charity, a community fund, or a research company to name a few non-limiting examples. The system then prompts the administrator account to select a specific package type from the list of package types and a desired quantity for the specific package type in order to designate the plurality of fundraiser packages, for example 50 boxes of bracelets. Preliminary information may additionally include contact and billing information for the recipient and the administrator account as well as any other details required to fully manage a fundraising campaign.

The fundraiser package is preferably a physical item and a mission statement note in a gift box. Various items may be used for the physical item but the preferred item is a beautiful bracelet that contains five beads distributed about the length of the bracelet to remind the wearer of the appreciation challenge. The bracelet may come in a multitude of varieties with different sizes, colors, and designs. The appreciation challenge is written down on the mission statement note along with additional content determined by the administrator account. In one embodiment of the present invention, one option within the list of package styles is a customizable package style. The customizable package style allows the administrator account to tailor the fundraiser package specifically to their fundraising campaign. The system enables the administrator account to select different physical and aesthetic attributes for the customizable package style. This may include customizing the bracelet and/or mission statement through the incorporation of personal colors, logos, and pictures to name a few non-limiting examples.

Another secondary process is related to the creation and manipulation of user accounts. Each user account is a means for an individual to access the features of the present invention. Each user account may include, but is not limited to, a user name, a password, password retrieval questions, an email address, a physical address, and the name of the individual. Upon the creation of each of the user accounts, the system prompts the individual to enter said descriptive information. The information is then encrypted and saved by the system.

Another secondary process is related to the webinar/program processes. The system provides a plurality of education lessons on the webinar/program portal. The system displays the webinar/program portal to a specific account from the plurality of user accounts via Internet-based application and prompts said specific account to select a desired lesson from the plurality of educational lessons. Educational lessons include videos, presentations, studies, articles, and interactive activities. Educational lessons are preferably related to gratitude-teaching content. In one embodiment, the educational lessons may also contain information regarding the fundraising campaign and information about the recipient of the fundraising campaign. The additional information will further educating the individual about the cause and purpose of the specific fundraising campaign which they chose. The system enables the specific account to interact with the desired lessons through the webinar/program portal and thus allowing the individual to consume educational material. The educational lessons may be updated and modified on a timely basis.

Another secondary process is the management of the common board. The common board is accessible to each user account through the Internet-based application. The common board compiles gratitude statements from the plurality of user accounts and displays them for others to see and interact with; the common board encourages a closer and more cohesive community. Each fundraising campaign contains a common board dedicated to the user accounts associated with the campaign; this is achieved through the assignment of access code to specific fundraising campaigns. One of the main purposes of the common board is to aid each participating individual in completing the appreciation challenge. The common board is especially beneficial for corporate and business environments where stronger and closer relationships may lead to increased productivity and happiness. The system periodically prompts a specific account from the plurality of user accounts to submit a gratitude statement; this is done according to a predetermined schedule. In one embodiment, the system sends a notification email to each of the user accounts as a reminder to submit a gratitude statement for that day, or a time increment preset by the administrator account. Once the system receives the gratitude statement from the specific account, the statement is posted to the common board of that specific fundraising campaign. This action enables each of the plurality of user accounts to comment and interact with each of the gratitude statements on the common board and thus with each other. In one embodiment, gratitude statements are posted anonymously. In another embodiment, the identity of the user accounts is posted alongside his/her gratitude statement. In yet another embodiment, each user account is given the option whether to post their identity or not.

Another secondary process allows an arbitrary user account to purchase one or more fundraiser packages through an online store portal. An arbitrary user account represents any individual without an access code that is interested in donating to the various fundraising campaigns of the present invention through either a direct donation or the purchase of fundraiser packages. Wherein the at least one administrator account is a plurality of administrator accounts, the online store portal allows the arbitrary user account to pick and choose which fundraiser campaign to support. The online store portal is populated by the plurality of fundraiser packages from each of the plurality of administrator accounts, i.e. fundraising campaigns. The system enables arbitrary user accounts to purchase from and/or directly donate to one of the plurality of administrator accounts. At the end of the fundraising campaign, the proceeds from the online store portal are collected into a single online fund. The system enables the recipient to access the single online fund.

Although the invention has been explained in relation to its preferred embodiment, it is to be understood that many other possible modifications and variations can be made without departing from the spirit and scope of the invention as hereinafter claimed.

What is claimed is:

1. A method of fundraising with an educational webinar/program by executing computer-executable instructions stored on a non-transitory computer-readable medium the method comprises the steps of:
providing an at least one administrator account and a list of package types;
receiving a request from the administrator account to setup a fundraising campaign;
designating preliminary information and a plurality of fundraiser packages for the fundraising campaign, wherein each of the plurality of fundraiser packages includes an access code;
placing a shipping order to send the plurality of fundraiser packages to contact information of the administrator account;
enabling the administrator account to sell the plurality of fundraiser packages to a plurality of contacts;
collecting proceeds from selling the plurality of fundraiser packages and sending the proceeds to a recipient;
receiving the access code for at least one of the plurality of fundraiser packages;
generating a plurality of user accounts, wherein each of the plurality of user accounts corresponds to a received access code from the plurality of fundraiser packages;
enabling the plurality of user accounts to access and view a webinar/program portal;
periodically retrieving gratitude statements from each of the plurality of user accounts according to a predetermined schedule;
displaying the gratitude statements from each of the plurality of user accounts onto a common board; and
enabling the plurality of user accounts to interact amongst each other through the common board.

2. The method of fundraising with an educational webinar/program by executing computer-executable instructions stored on a non-transitory computer-readable medium, the method as claimed in claim 1 comprises the steps of:
wherein the preliminary information describes a recipient of the fundraising campaign, a specific package type, and a desired quantity of the specific package type;
prompting the administrator account to select the recipient of the fundraising campaign;
prompting the administrator account to select the specific package type from the list of package types; and
prompting the administrator account to select the desired quantity for the specific package type in order to designate the plurality of fundraiser packages.

3. The method of fundraising with an educational webinar/program by executing computer-executable instructions stored on a non-transitory computer-readable medium, the method as claimed in claim 1, wherein each of the plurality of fundraiser packages is a physical item and a mission statement note in a gift box.

4. The method of fundraising with an educational webinar/program by executing computer-executable instructions stored on a non-transitory computer-readable medium, the method as claimed in claim 3 comprises the steps of:
wherein one option within the list of package styles is a customizable package style; and
enabling the administrator account to select different physical and aesthetic attributes for the customizable package style.

5. The method of fundraising with an educational webinar/program by executing computer-executable instructions stored on a non-transitory computer-readable medium, the method as claimed in claim 1 comprises the steps of:
wherein the at least one administrator account is a plurality of administrator accounts;
providing a online store portal;
populating the online store portal with the plurality of fundraiser packages from each of the plurality of administrator accounts;
enabling an arbitrary user account to purchase from one of the plurality of administrator accounts; and
enabling the arbitrary user account to directly donate to one of the plurality of administrator accounts.

6. The method of fundraising with an educational webinar/program by executing computer-executable instructions stored on a non-transitory computer-readable medium, the method as claimed in claim 1 comprises the steps of:
collecting electronic funds as the proceeds into a single online fund; and
enabling the recipient to access the single online fund.

7. The method of fundraising with an educational webinar/program by executing computer-executable instructions stored on a non-transitory computer-readable medium, the method as claimed in claim 1 comprises the steps of:
providing a plurality of educational lessons on the webinar/program portal;
displaying the webinar/program portal to a specific account from the plurality of user accounts;
prompting the specific account to select a desired lesson from the plurality of the educational lessons; and
enabling the specific account to interact with the desired lesson through the webinar/program portal.

8. The method of fundraising with an educational webinar/program by executing computer-executable instructions stored on a non-transitory computer-readable medium, the method as claimed in claim 7, wherein each of the plurality of educational lessons includes gratitude-teaching content.

9. The method of fundraising with an educational webinar/program by executing computer-executable instructions stored on a non-transitory computer-readable medium, the method as claimed in claim 1 comprises the steps of:
periodically prompting a specific account from the plurality of user accounts to submit the gratitude statements according to the predetermined schedule;
receiving the gratitude statements from the specific account;
posting the gratitude statements from the specific account to the common board; and
enabling each of the plurality of user accounts to comment and interact with each of the gratitude statements on the common board.

10. The method of fundraising with an educational webinar/program by executing computer-executable instructions stored on a non-transitory computer-readable medium, the method as claimed in claim 9, wherein the gratitude statement includes user-determined list of things describing what a user is grateful for in their lives.
